(19) United States
(12) Patent Application Publication
(10) Pub. No.: US 2024/0261169 A1
(43) Pub. Date: Aug. 8, 2024

(54) PATIENT SUPPORT MODULE COMPRISING A QUICK RELEASE MECHANISM

(71) Applicant: Stille AB, Torshälla (SE)

(72) Inventors: Ralph TAMM, Skogstorp (SE); Gniewomir GORDZIEJ, Torshälla (SE)

(21) Appl. No.: 18/426,932

(22) Filed: Jan. 30, 2024

(30) Foreign Application Priority Data
Feb. 3, 2023 (EP) 23154948.6

(51) Int. Cl. A61G 13/12

(52) U.S. Cl. CPC A61G 13/1285

(57) ABSTRACT

The present disclosure relates to a module connectable to a medical procedure tabletop, wherein the module includes a coupling section allowing for quick and safe connection and disconnection of the module to a medical procedure tabletop. The present disclosure further relates to a medical procedure tabletop having such a module.

### RELATED APPLICATION DATA

This application claims the benefit of European patent application Ser. No. 23/154,948.6, filed Feb. 3, 2023, the content of which is incorporated herein by reference in its entirety.

### TECHNICAL FIELD

The present disclosure relates generally to a module connectable to a medical procedure tabletop comprising a coupling section allowing for quick and safe connection and release of the module to a medical procedure tabletop. Further, the present disclosure relates to a medical procedure tabletop comprising such a module.

### BACKGROUND ART

A conventional medical procedure tabletop comprises a central part to which different patient supporting modules can be connected to depending on the desired functionality or functionalities to be provided.

Modules connectable to such a central part are known in the art. These modules can serve different purposes such as supporting specific parts of a patient such as head or legs. Moreover, the modules may be configured to be suitable for specific medical operations such as X-ray procedures, diagnostical procedures or surgical procedures, or may be configured to provide a specific patient positioning.

It is essential that a module connectable to a medical procedure tabletop is easy to connect to a tabletop and that the connection is secure, i.e. low risk of unvoluntary disconnection (i.e. disengagement) from the tabletop. Furthermore, it is also preferable that the connection is made in an effective manner in order to save time during time sensitive procedures.

Different solutions to the above mentioned requirements have been proposed, for instance in WO13069952, and U.S. Pat. No. 8,997,281.

WO13069952 discloses a separation type bed wherein two parts are detachably coupled by a male-female type of mechanism located at the side of the bed.

U.S. Pat. No. 8,997,281 discloses an operating table with connectable modules, wherein the modules are connected to a central table portion by a spring hook member that is released by pressing an actuator in a downwards direction.

None of the solutions previously known in the prior art provide for a module connectable to a medical procedure tabletop having a connection mechanism that reduces the risks of unvoluntary disconnection. For instance, during usage of a medical tabletop, a great deal of movement of both personnel and equipment is usually occurring. As such, if the connection mechanism of a module attached to the tabletop is located in a location that is prone to contact with another object, this could unvoluntary trigger the disengagement of the module. Also, it is important that the movement required to disengage the module is not a movement that a medical operator might accidentally do when operating around the medical tabletop, such as for instance approaching the medical tabletop or treating a patient.

To the applicant's best knowledge, there is still a need for a module connectable to a medical procedure tabletop solving the above-mentioned problems.

### SUMMARY OF INVENTION

An object of the present disclosure is to provide a module connectable to a medical procedure tabletop, wherein the module comprises a connection mechanism that allows for easy and secure connection of the module to a medical procedure tabletop.

Another object of the present disclosure is to provide a module connectable to a medical procedure tabletop, wherein the connection mechanism reduces the risk of unvoluntary disconnection of the module from a medical procedure tabletop.

Another object of the present disclosure is to provide a module connectable to a medical procedure tabletop, wherein the module is configured to be suitable for X-ray procedures.

Another object of the present disclosure is to provide a module connectable to a medical procedure tabletop delivering a safe working load of 300 kg.

In a first aspect, the present disclosure is directed to a module connectable to a medical procedure tabletop, the module having a patient facing side and a lower side opposite to the patient facing side. The module has a first end directed towards a medical procedure tabletop, an opposite second end and a longitudinal axis defined therebetween, wherein a coupling section is arranged towards the first end. The coupling section being configured to engage with a corresponding coupling section of a medical procedure tabletop thereby connecting the module to a medical procedure tabletop. The coupling section comprises:

a sliding latch having a sliding extension substantially along the longitudinal axis;

a latch activator coupled to the sliding latch, wherein the latch activator is configured to slide the sliding latch substantially along the longitudinal axis. The latch activator being configured to, when the module is engaged with a corresponding coupling section of a medical procedure tabletop, to slide substantially towards the second end along the longitudinal axis in order to disengage the coupling section from a corresponding coupling section.

In the context of the present disclosure, the term “medical procedure tabletop” should be interpreted as a top surface of a medical table, i.e. a table where a medical procedure can be performed. The procedure may be a non-invasive procedure such as examination or diagnosis, or invasive such as surgery, operations or treatment. “Medical procedure tabletop” may be, but not limited to, a surgical table, examination table, hospital bed etc.

In the context of the present disclosure it should be understood that, when the module is engaged with a corresponding coupling section of a medical procedure tabletop, the module is connected to the medical procedure tabletop.

A medical procedure tabletop thus forms a central part to which a module according to the present disclosure can be attached to.

The sliding latch functions as a lock mechanism keeping the module in a locked position when engaged, i.e. connected, with a corresponding coupling section of a medical procedure tabletop. In order to disengage, i.e. disconnect, the module from a medical procedure tabletop, the sliding latch needs to be moved towards the second end of the tabletop, i.e. away from a medical treatment tabletop. This reduces the risk of unvoluntary disengagement of the module by the interaction of objects mowing towards a medical procedure tabletop, by the medical tabletop being lowered, or by medical operators treating a patient on the tabletop.

The latch activator may be coupled with the sliding latch, or be an integral part of the sliding latch. The latch activator functions as a mean for a user to slide the latch in a direction substantially along the longitudinal axis formed by the module to engage the module with a corresponding coupling section and/or disengage the module from a corresponding coupling section.

The module may be any suitable module connectable to a medical procedure tabletop, such as, but not limited to, a patient support, head rest, or a patient positioning module allowing for supine position, prone position, lateral decubitus position, surgical positions, cardiovascular surgery positions, gynaecological positions or/and urological positions.

In one embodiment, the sliding latch has a sliding extension along the longitudinal axis, the latch activator is configured to slide the sliding latch along the longitudinal axis, and the latch activator is configured to slide towards the second end along the longitudinal axis in order to disengage the coupling form a corresponding coupling section.

In one embodiment, the latch activator has an extension essentially towards the lower side.

By essentially towards the lower side is meant merely that a high degree of precision is not required. As will be understood by those skilled in the art, a small amount of misalignment can be tolerated. The important point is to maintain sufficient alignment towards the lower side to assure that the latch activator extends towards the lower side. In one embodiment, the latch activator has an extension towards the lower side.

By such an exemplary module, unvoluntary disengagement of the module is further reduced as the extension of the latch activator towards the lower side of module creates a more compact solution with less parts extending outwards from the side of the module.

In one embodiment, the latch activator protrudes through the lower side.

By such an exemplary module, unvoluntary disengagement of the module is further reduced as the latch activator will be located underneath the patient facing side. An operator of a medical procedure tabletop must, in order to disengage the module from a corresponding coupling section of a medical procedure tabletop, reach under the patient facing side. This, in combination with the disengagement of the module being achieved by the movement of the latch activator in a direction away from a medical procedure tabletop, further reduces the risk of unvoluntary disengagement of the module.

In one embodiment, the coupling section comprises a resilient member configured to provide a force acting on the sliding latch towards the first end. Preferably the resilient member is selected from a spring, a motor, a pneumatic system or a liquid hydraulic system.

By such an exemplary module, the module is self-latching, i.e. self-locking. Once the module is in the correct engagement position with a corresponding coupling section of a medical procedure tabletop, the force acting on the sliding latch towards the first end provided by the resilient member ensures that the latch locks the module in place.

A self-latching module is desirable in order to provide for a quick and easy connection, i.e. engagement, of the module with a medical procedure tabletop.

In one embodiment, the coupling section is essentially hook-shaped.

By essentially hook-shape is meant merely that a high degree of precision is not required. The important point is to maintain the general geometry of a hook, thus comprising a shank, a bend and a point. In one embodiment, the coupling section is hook-shaped.

Preferably, the essentially hook-shaped coupling section comprises a shank part extending from the patient facing side towards the lower side, a hook point forming the tip of the hook, and a bend part in between the shank part and the hook point.

In the context of the present disclosure, the term “hook point” should be interpreted as the tip of the hook.

In the context of the present disclosure, the term “gape” should be interpreted as the distance between the hook point and the shank, measured in a direction parallel to the patient facing side.

In one embodiment, the essentially hook-shaped coupling section, when engaged with a corresponding essentially hook-shaped coupling section of a medical procedure tabletop, is configured to form a hook scarf joint.

By such an exemplary module, a scarf joint is formed providing good load bearing capabilities.

In one embodiment, the coupling section comprises a first section facing towards the lower side, and a second section in connection with the first section facing essentially towards the patient facing side, wherein:

said first section is configured to engage with a corresponding first section of a corresponding coupling section of a medical procedure tabletop, and to distribute a load acting on the patient facing side of the module in a direction essentially towards the lower side to the corresponding first section;

said second section is configured to engage with a corresponding second section of a corresponding coupling section of a medical procedure tabletop, and to distribute a load acting on the patient facing side of the module in a direction essentially towards the patient facing side to the corresponding second section.

By “essentially towards the patient facing side” is meant merely that a high degree of precision is not required. As will be understood by those skilled in the art, a small amount of misalignment can be tolerated. The important point is to maintain sufficient alignment towards the patient facing. It is to be understood that the term essentially may be omitted when defining a direction “towards the patient facing side.”

By “essentially towards the lower side” is meant merely that a high degree of precision is not required. As will be understood by those skilled in the art, a small amount of misalignment can be tolerated. The important point is to maintain sufficient alignment towards the lower side. It is to be understood that the term essentially may be omitted when defining a direction “towards the lower side”.

In the context of the present disclosure, “distribute a load” should be interpreted as the spreading out of a load from one surface or section to a second surface or section.

By such an exemplary module, the connection of the module to a medical procedure tabletop and the load bearing of the module is further improved. When a load is applied on the patient facing side of the module, the coupling section keeps the module in place and inhibits the module from falling down.

When such an exemplary module is connected to a medical procedure tabletop and a load is applied on the patient facing side of the module, the first section and the second section provides two different load distribution mechanisms. The first section being configured to distribute a load acting on the patient facing side essentially towards the lower side, effectively rests on a corresponding first section of a corresponding coupling section of a medical procedure tabletop, and thus transfers to load to the corresponding first section. By doing so, the first section thus provides an impediment for the module from falling down.

Correspondingly, when such an exemplary module is connected to a medical procedure tabletop and a load is applied on the patient facing side of the module, the second section (facing essentially towards the patient facing side) experiences a load towards the patient facing side and is pushed in a direction essentially towards the patient facing side. The load distribution from the second section to a corresponding second section of a corresponding coupling section of a medical procedure tabletop results in a more fixed engagement of the module with a medical procedure tabletop and prevents the module from moving in a downwards direction when a load is applied on the patient facing side.

The first section is preferably facing towards the lower side. The corresponding first section is preferably facing towards the patient facing side. The second section is preferably facing towards the patient facing side. The corresponding second section is preferably facing towards the lower side.

In one embodiment, the first section and the second section are, when the module is connected to a medical procedure tabletop, in contact engagement with a corresponding first section and a corresponding second section respectively of a corresponding coupling section of a medical procedure tabletop.

In one embodiment, the first section has a length of between 5-25 mm and the second section has a length of between 10-40 mm.

In one embodiment, the ratio between a length of the first section and a length of the second section is between 0.5-0.75.

It is important that the length of the first section and the second section are selected so to allow for sufficient load distribution while not impeding the handling of the module. If the lengths are too small, the load bearing capabilities are impaired. If the lengths are too large, the connection of the module to a medical procedure table may become cumbersome. It has been discovered that lengths of the first and second section according to the present disclosure provides for good load bearing capabilities while still providing an easy connection, i.e. engagement, of the module to a medical procedure tabletop.

In one embodiment, the module when connected to a medical procedure tabletop has a safe working load of 300 kg.

In the context of the present disclosure, “safe working load” should be interpreted as the maximum safe load that a medical procedure table and the module can lift, move, suspend and lower down to the ground without breaking when a load is distributed continuously over the module and a medical procedure tabletop, i.e. a continuous load distribution.

In one embodiment, the module is suitable for X-ray procedure.

By such an exemplary module, a module with reduced absorption of X-rays and increased service life of the X-ray sources utilized is achieve. Materials suitable for X-ray operations are known for instance from WO 2014168532 A1.

In one embodiment, the module has an X-ray attenuation equivalence of less than 0.6 mm Al at 100 kV, preferably equal or less than 0.4 mm Al at 100 kV.

The X-ray attenuation equivalence tested using a RTI Barracuda w. R100B detector according to IEC 6061-1-3:1994 at MEDIEL AB's facility in Molndal, Sweden.

In one embodiment, the module is carbon fibre reinforced.

By such an exemplary module, a module is achieved having improved mechanical strength and favourable low X-ray absorption.

In one embodiment, the module has a thickness of less than 40 mm.

A small thickness is desirable for instance in X-ray operations as less material interfere with the X-rays.

In one embodiment, the coupling section is configured to, in order to engage with a corresponding coupling section of a medical procedure tabletop, be tilted between 10-30 degrees in relation to a corresponding coupling section of a medical procedure tabletop.

By such a module, easy connection and releasing of the module from a medical procedure tabletop can be achieved as the module does not need to be tilted excessively by an operator to elevated angles.

By “tilted between 10-30 degrees in relation to a corresponding coupling section of a medical procedure tabletop” is meant the angle formed between the longitudinal extension of the module and a longitudinal extension of the medical procedure tabletop”.

In a second aspect, the present disclosure relates to a medical procedure tabletop comprising a module according to any one of the first aspect.

In one embodiment, the medical procedure tabletop comprises a corresponding coupling section configured to engage with a coupling section of the module.

### BRIEF DESCRIPTION OF DRAWINGS

The invention is now described, by way of example, with reference to the accompanying drawings, in which:

FIG. 1 illustrates a side view of a module connectable to a medical procedure tabletop according to one embodiment of the present disclosure.

FIG. 2A illustrates a side view of a module connectable to a medical procedure tabletop according to one embodiment of the present disclosure during a starting stage of an engagement with a medical procedure tabletop.

FIG. 2B illustrates a side view of a module connectable to a medical procedure tabletop according to one embodiment of the present disclosure during a final stage of an engagement with a medical procedure tabletop.

FIG. 2C illustrates a side view of a module connectable to a medical procedure tabletop according to one embodiment of the present disclosure in engagement with a medical procedure tabletop.

FIG. 3A illustrates an upper lateral view of a module connectable to a medical procedure tabletop according to one embodiment of the present disclosure during a starting stage of an engagement with a medical procedure tabletop.

FIG. 3B illustrates an upper lateral view of a module connectable to a medical procedure tabletop according to one embodiment of the present disclosure during a final stage of an engagement with a medical procedure tabletop.

FIG. 3C illustrates an upper lateral view of a module connectable to a medical procedure tabletop according to one embodiment of the present disclosure in engagement with a medical procedure tabletop.

FIG. 4 illustrates a lower lateral view of a module connectable to a medical procedure tabletop according to one embodiment of the present disclosure in engagement with a medical procedure tabletop.

FIG. 5 illustrates a medical procedure tabletop comprising a connected module according to one embodiment of the present disclosure.

The detailed description with reference to the disclosed embodiments are to be viewed as examples of combining specific features described above. It is to be understood that additional examples may be achieved by combining other and/or fewer/more features than in the disclosed embodiments. Hence, the figures disclose exemplary embodiments and not exclusive combinations. In this context is should also be noted that, for the sake of simplicity, all figures are schematically disclosed, as long as nothing else is said.

### DESCRIPTION OF EMBODIMENTS

The detailed description with reference to the disclosed embodiments are to be viewed as examples of combining specific features described above. It is to be understood that additional examples may be achieved by combining other and/or fewer/more features than in the disclosed embodiments. Hence, the figures disclose exemplary embodiments and not exclusive combinations. In this context is should also be noted that, for the sake of simplicity, all figures are schematically disclosed, as long as nothing else is said.

The present disclosure relates to a module connectable to a medical procedure tabletop, wherein the module comprises a coupling section allowing for a quick and secure connection of the module with a medical procedure tabletop, as well as reduced probability of an unvoluntary disengagement of the module from a medical procedure tabletop.

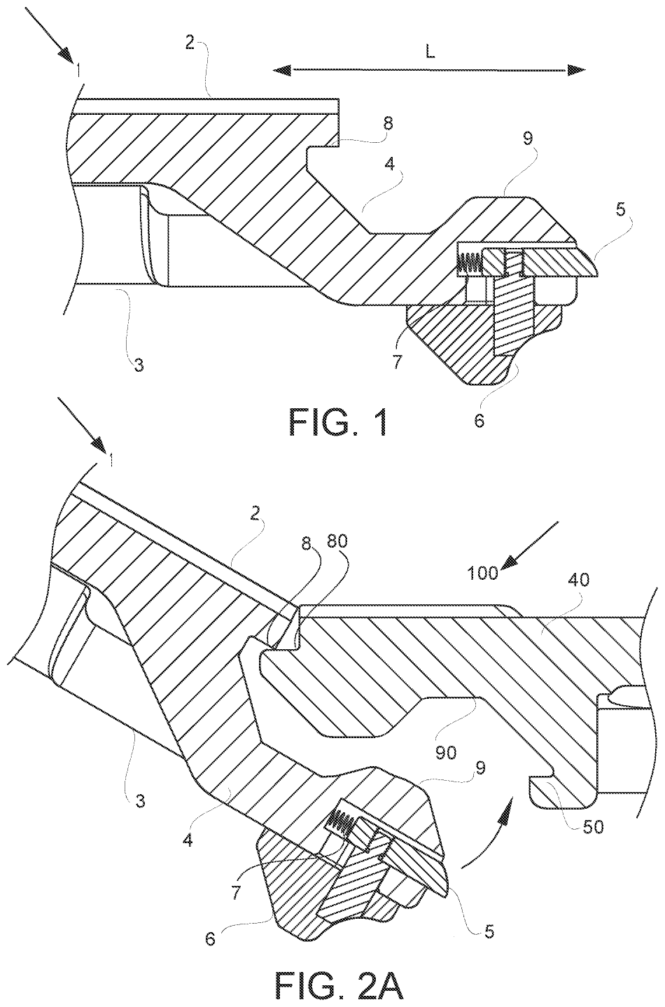

FIG. 1 illustrates a side view of a module 1 according to one embodiment of the present disclosure. As can be seen in FIG. 1, the module 1 illustrated comprises a patient facing side 2 for supporting a patient and a lower side 3 located at the opposite side of the module 1. FIG. 1 illustrates a module 1 showing a first end of the module 1. The module 1 comprises an opposite second end, not illustrated in FIG. 1, wherein a longitudinal axis L is defined between the first end and the second end.

The module 1 comprises a generally hook shaped coupling section 4 arranged towards the first end of the module 1. The coupling section 4 being configured to engage with a corresponding, i.e. mating, coupling section of a medical procedure tabletop (not illustrated in FIG. 1) to which the module 1 is intended to be connected upon.

The coupling section 4 comprises inside its structure a sliding latch 5 protruding through the coupling section 4. The sliding latch 5 has a sliding extension substantially along the longitudinal axis L. Furthermore, the coupling section 4 comprising a latch activator 6 coupled to the sliding latch 5. The latch activator 6 is configured to slide the sliding latch 5 substantially along the longitudinal axis L.

As can be seen in FIG. 1, the latch activator 6 has an extension towards the lower side 3 and protrudes through the lower side 3 so to be reachable for a medical operator when reaching under the module 1.

The coupling section 4 illustrated in FIG. 1 further comprises a resilient member 7 in the form of a spring. The resilient member 7 is configured to provide a force acting on the sliding latch 5 towards the first end.

The coupling section 4 illustrated in FIG. 1 further comprises a first section 8 facing towards the lower side 3 and a second section 9 facing towards the patient facing side 2 and in connection with the first section 8.

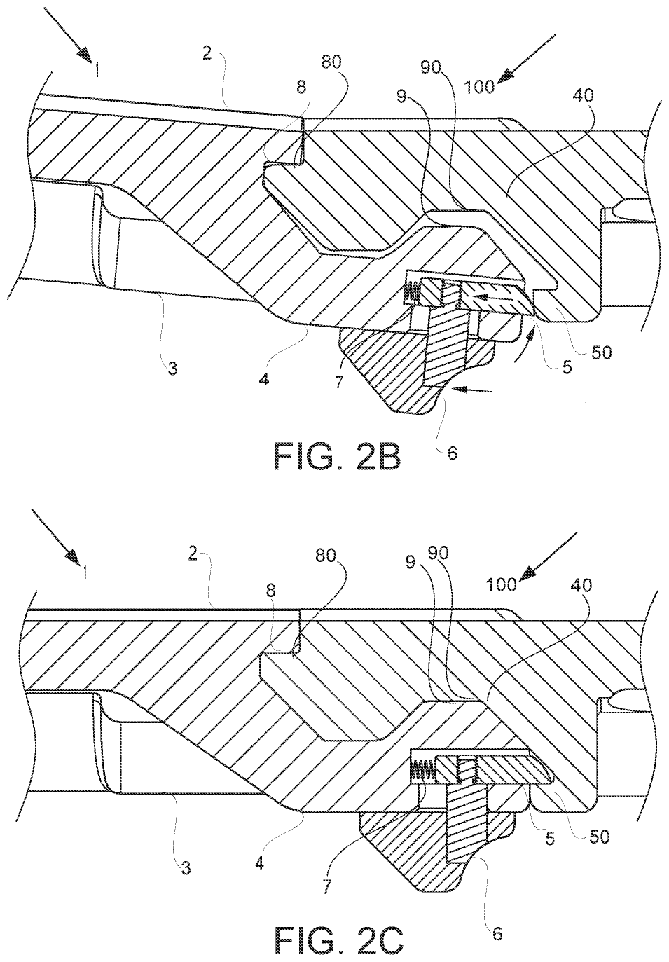

Turning now to FIG. 2A illustrating a side view of a module 1 connectable to a medical procedure tabletop according to one embodiment of the present disclosure during a starting stage of an engagement with a medical procedure tabletop 100.

When the module 1 is to be connected to a medical procedure tabletop 100, the module is tilted upwards in relation to the medical procedure tabletop 100 so that a part of the coupling section 4 comprising the sliding latch 5 and the second section 9 is located below the medical procedure tabletop 100, as illustrated in FIG. 2A to FIG. 2C.

The medical procedure tabletop 100 comprises a corresponding coupling section 40 configured to engage with the coupling section 4 of the module 1. The corresponding coupling section 40 comprises a corresponding first section 80 configured to engage with the first section 8 of the module 1, and further comprises a corresponding second section 90 configured to engage with the second section 9 of the module 1.

As illustrated in FIG. 2A to FIG. 2C, when the first section 8 of module 1 is in contact with the corresponding first section 80 of the medical procedure tabletop 100, the module 1 is tilted downwards so that the second section 9 of the module 1 is moved upwards towards the corresponding second section 90 of the medical procedure tabletop 100.

Turning now to FIG. 2B illustrating a side view of a module 1 connectable to a medical procedure tabletop 100 according to one embodiment of the present disclosure. In FIG. 2B, the module 1 is illustrated during a final stage of engagement with a medical procedure tabletop 100.

When the tilting movement of module 1 is continued, the sliding latch 5 will come in contact with a locking section 50 arranged on the corresponding coupling section 40 of the medical procedure tabletop 100. The sliding latch 5 is configured so that tilting movement of module 1 results in that the locking section 50 pushes the sliding latch 5 towards the second end of the module. As a consequence, also the latch activator 6 is moved towards the second end.

Turning now to FIG. 2C illustrating a side view of a module 1 connectable to a medical procedure tabletop 100 according to one embodiment of the present disclosure. In FIG. 2C, the module 1 is illustrated in engagement (i.e. connected) with a medical procedure tabletop 100.

As can be seen, the first section 8 of the coupling section 4 is now in engagement (i.e. contact) with the corresponding first section 80 of the medical procedure tabletop 100 so that the first section 8 rests on the corresponding first section 80. Furthermore, the second section 9 of the coupling section 4 is now in engagement (i.e. contact) with the corresponding second section 90 of the medical procedure tabletop 100.

When the module 1 is in engagement with a medical procedure tabletop 100, the sliding latch 5 is in engagement with the locking section 50 so to lock the module 1 in place to the medical procedure tabletop 100.

If a user wants to disengage the module 1 from its engagement with the medical procedure tabletop 100, the sliding latch 5 is simply moved towards the second end by moving the latch activator 6 towards the second end. The sliding latch 5 is freed from its engagement with the locking section 50 so that the module 1 can be tilted in a reverse manner compared to when engaging the module 1 to the medical procedure tabletop 100.

As has been previously described, the sliding movement of the latch activator 6 towards the second end required to disengage the module 1 from its engagement with the medical procedure tabletop 100 reduces the risks of unvoluntary disconnection of the module 1 from the medical procedure tabletop 100. This is because accidental contact with the latch activator 6 is both inhibited by the medical procedure tabletop 100, and in that the latch activator 6 is located underneath the patient facing side.

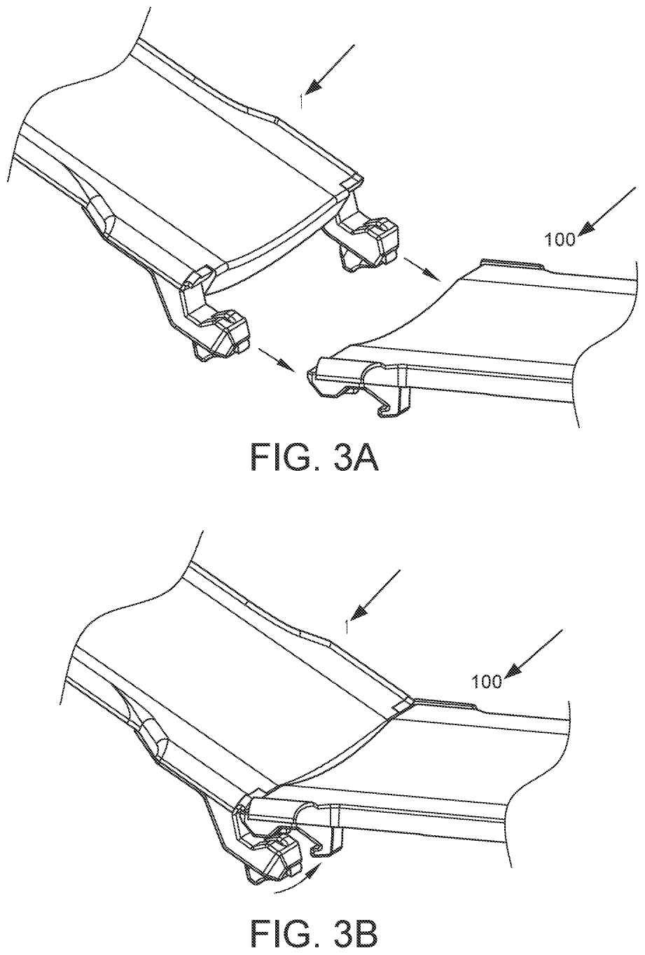

Turning now to FIGS. 3A-3C illustrating the engagement procedure of module 1 to a medical procedure tabletop 100 as illustrated in FIGS. 2A-2C but from an upper lateral view.

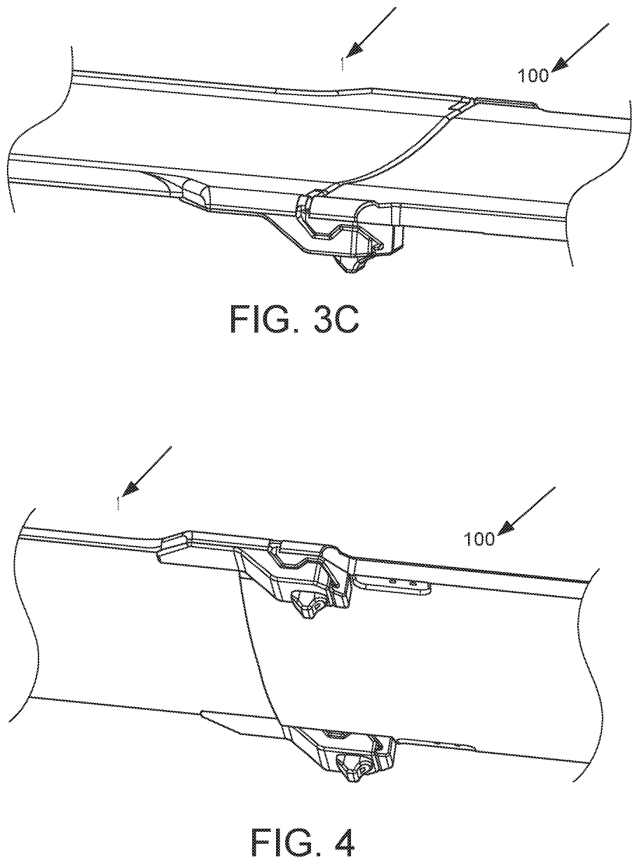

Turning now to FIG. 4 illustrating a module 1 according to an embodiment of the present disclosure in engagement with a medical procedure tabletop 100 from a lower lateral view.

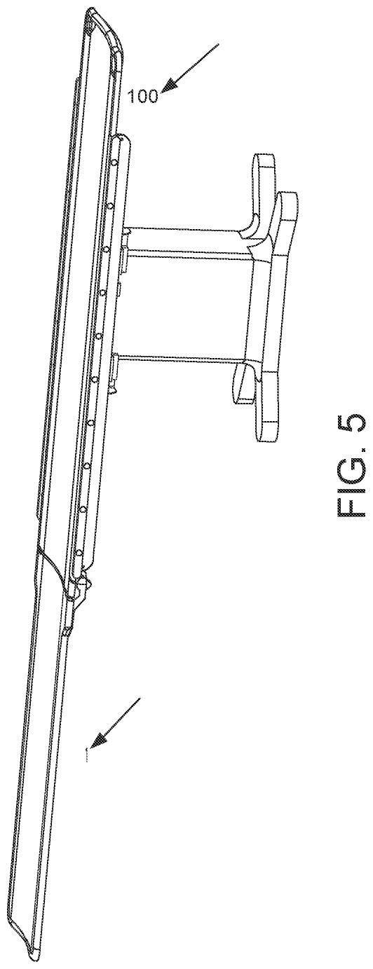

Turning now to FIG. 5 illustrating a module 1 according to an embodiment of the present disclosure in engagement with a medical procedure tabletop 100 from a side view.

What is claimed is:

1. A module connectable to a medical procedure tabletop, the module having a patient facing side and a lower side opposite the patient facing side, wherein the module has a first end directed towards a medical procedure tabletop, an opposite second end and a longitudinal axis defined therebetween, wherein a coupling section is arranged towards the first end, the coupling section being configured to engage with a corresponding coupling section of a medical procedure tabletop thereby connecting the module to a medical procedure tabletop, wherein the coupling section comprises:
(i) a sliding latch having a sliding extension substantially along the longitudinal axis;
(ii) a latch activator coupled to the sliding latch, wherein the latch activator is configured to slide the sliding latch substantially along the longitudinal axis;
wherein the latch activator being configured to, when the module is engaged with a corresponding coupling section of a medical procedure tabletop, to slide substantially towards the second end along the longitudinal axis in order to disengage the coupling section from a corresponding coupling section of a medical procedure tabletop.

2. The module according to claim 1, wherein the latch activator has an extension essentially towards the lower side.

3. The module according to claim 1, wherein the latch activator protrudes through the lower side.

4. The module according to claim 1, wherein the coupling section comprises a resilient member configured to provide a force acting on the sliding latch towards the first end, preferably the resilient member is selected from a spring, a motor, a pneumatic system or a liquid hydraulic system.

5. The module according to claim 1, wherein the coupling section is essentially hook-shaped.

6. The module according to claim 5, wherein the essentially hook-shaped coupling section, when engaged with a corresponding essentially hook-shaped coupling section of a medical procedure tabletop, is configured to form a hook scarf joint.

7. The module according to claim 1, wherein the coupling section comprises a first section facing towards the lower side, and a second section in connection with the first section facing essentially towards the patient facing side, wherein:
said first section is configured to engage with a corresponding first section of a corresponding coupling section of a medical procedure tabletop, and to distribute a load acting on the patient facing side of the module in a direction essentially towards the lower side to the corresponding first section;
said second section is configured to engage with a corresponding second section of a corresponding coupling section of a medical procedure tabletop, and to distribute a load acting on the patient facing side of the module in a direction essentially towards the patient facing side to the corresponding second section.

8. The module according to claim 7, wherein the first section has a length of between 5-25 mm and the second section has a length of between 10-40 mm.

9. The module ratio according to claim 8, wherein a ratio between a length of the first section and a length of the second section is between 0.5-0.75.

10. The module according to claim 1, wherein the module, when connected to a medical procedure tabletop, has a safe working load of 300 kg.

11. The module according to claim 1, wherein the module is suitable for X-ray procedure.

12. The module according to claim 11, wherein the module has an X-ray attenuation equivalence of less than 0.6 mm Al at 100 kV, preferably equal or less than 0.4 mm Al at 100 kV.

13. The module according to claim 1, wherein the module is carbon fibre reinforced.

14. The module according to claim 1, wherein the module has a thickness of less than 40 mm.

15. The module according to claim 1, wherein the coupling section is configured to, in order to engage with a corresponding coupling section of a medical procedure tabletop, be tilted between 10-30 degrees in relation to a corresponding coupling section of a medical procedure tabletop.

16. A medical procedure tabletop comprising a module according to claim 1.

17. The medical procedure tabletop according to claim 16, wherein the medical procedure tabletop comprises a corresponding coupling section configured to engage with a coupling section of the module.
